(19) United States
(12) Patent Application Publication
(10) Pub. No.: US 2007/0255730 A1
(43) Pub. Date: Nov. 1, 2007

(54) DATA REQUIREMENTS METHODOLOGY

(76) Inventor: Robert Mack, Hillsborough, NJ (US)

Correspondence Address: WALTER J, TENCZA JR., 10 STATION PLACE, SUITE 3, METUCHEN, NJ, 08840, US

(21) Appl. No.: 11/308,723

(22) Filed: Apr. 26, 2006

(51) Int. Cl. G06F 7/00; G06F 9/44

(52) U.S. Cl. 707/100

(57) ABSTRACT

A method is provided including storing a first set of characteristics for each of a first set of one or more defined objects in a computer memory, storing a second set of characteristics for each of one or more data item classes in a computer memory, and storing a third set of characteristics for each of one or more data items in a computer memory. The method may further include linking the first set of one or more defined objects to one of the one or more data item classes and assigning a first data item of the one or more data items to a first data item class of the one or more data item classes.

### FIELD OF THE INVENTION

This invention relates to improved methods and apparatus concerning computer data bases.

### BACKGROUND OF THE INVENTION

Data requirements are collected by many organizations for many different reasons. Organizations collect data requirements as part of a database design methodology, to design data interfaces, to design software applications, as well as other design initiatives. In the prior art, these data requirements were gathered and documented in various ways. Most often, the data requirements were merely presented as a list of requirement statements in a functional requirements document for analysts to review. The current state of the art for data requirements is to use a CASE (Computer Aided Software Engineering) tool for recording the gathered data requirements. These CASE tools present the data requirements as a list of statements. Sometimes these tools allow the requirements to be grouped together based upon some common area of interest. The more sophisticated CASE tools allow the data analyst to associate logical data modeling elements to data requirements that the element was designed to fulfill.

Several problems arise with then use of these data requirements lists. These problems are: (1) Determining when the list of data requirements is complete, (2) determining that multiple data requirements do not contradict each other, (3) determining the impact of new data requirements with all other data requirements.

Today, data requirements and functionality requirements are often the start of software systems design. If the quality of data requirements can be improved, the resulting software system should be more efficiently developed.

### SUMMARY OF THE INVENTION

One or more embodiments of the present invention are based upon a perception that all data items may be classified into a common framework. The framework boundary is defined by an architected skeleton of defined objects upon which the data items rely for their classification.

In the data requirements methodology, method or apparatus of one or more embodiments of the present invention, data requirements are used to:

Develop defined objects and determine their placement into the architected skeleton.

Craft data items to support specific data requirements.

Determine all data item associations to the defined objects.

Select the data items that may be used to identify a specified defined object within a specified data context.

Particularize how new data items may be derived from other data items.

Detail methods for transforming data items from one data item classification into another.

The classification of all data items within the architected skeleton is what results from the data requirements methodology. Prior to one or more embodiments of the present invention, a data requirements framework such as this did not exist. The data requirements methodology results in a single coherent and comprehensive understanding of the data needs. The designer may now determine when the data requirements are complete, knowing that there are no conflicting requirements.

At least one embodiment of the present invention includes a method comprising storing a first set of characteristics for each of a first set of one or more defined objects in a computer memory, storing a second set of characteristics for each of one or more data item classes in a computer memory, and storing a third set of characteristics for each of one or more data items in a computer memory. The method may further include linking the first set of one or more defined objects to one of the one or more data item classes and assigning a first data item of the one or more data items to a first data item class of the one or more data item classes. Each of the first set of characteristics may be comprised of a defined object name, and a definition, each second set of characteristics is comprised of a list of links that uniquely identify one of the one or more data item classes, and each of the third set of characteristics is comprised of a data item name and a data item description.

The first set of one or more defined objects may be linked to the first data item class by one or more links, which are stored in a computer memory. Each of the one or more links may include a data item class identifier and a defined object identifier. Each first set of characteristics may be comprised of a unique identifier, which is stored in a database table in the computer memory. Each first set of characteristics may be further comprised of an interrogative and/or a reference string name. Each reference string name may identify a reference string comprised of a second set of one or more defined objects wherein the second set of one or more define objects is similar in classification to the first set of one or more defined objects. Each first set of characteristics may be comprised of an inherited defined object name.

Each of the inherited defined object names may refer to an inherited defined object which has a fourth set of characteristics which include just one first interrogative and each of the first set of one or more defined objects may also include just one interrogative which is the same first interrogative. Each of the inherited defined objects of each of the inherited defined object names may be of less granular definition than of any of the defined objects of the first set of one or more defined objects. Each first set of characteristics may be comprised of a defined object synonym.

In one embodiment of the present invention any apparatus is provide comprising a computer memory and a processor programmed to implement a plurality of data requirements. The plurality of data requirements may be as previously described.

### BRIEF DESCRIPTION OF THE DRAWINGS

FIG. 1 shows an apparatus including a computer memory for use in accordance with one or more embodiments of the present invention;

FIG. 2 shows a table of data including requirement object names and requirement object categorizations, which may be stored in a computer data base of the computer memory shown in FIG. 1;

FIG. 3 shows a table of data including requirement object names and their interrogative classifications, which may be stored in a computer data base of the computer memory shown in FIG. 1;

FIG. 4 shows a table of data including defined objects and their identifying data items for a specified data context, which may be stored in a computer data base of the computer memory shown in FIG. 1;

FIG. 5 shows a table of data, including two networked reference strings, which may be stored in a computer data base of the computer memory shown in FIG. 1;

FIG. 6 is a diagram showing a data item completely defined into a data item class;

FIG. 7 is a diagram showing two base data items and a derived data item occupying the same data item class;

FIG. 8 shows a table of data, including derived data within a data item class, which may be stored in a computer data base of the computer memory shown in FIG. 1;

FIG. 9 is a diagram depicting two data item class transformation methods that perform changes in granularity within a reference string;

FIG. 10 is a diagram depicting a data item class transformation using the reference string aggregation method;

FIG. 11 shows a table of data, which demonstrates a change in data item class by the reference string aggregation method;

FIG. 12 is a diagram, which depicts a data item class transformation using the reference string allocation method;

FIG. 13 shows a table of data showing a change of data item class by using the reference string allocation method;

FIG. 14 is a diagram depicting a data item class transformation using the reference string augmentation method;

FIG. 15 shows a table of data showing a change in data item class by using the reference string augmentation method;

FIG. 16 is a diagram depicting a data item class transformation using the reference string consolidation method; and

FIG. 17 shows a table of data showing a change in data item class by using the reference string consolidation method.

### DETAILED DESCRIPTION OF THE DRAWINGS

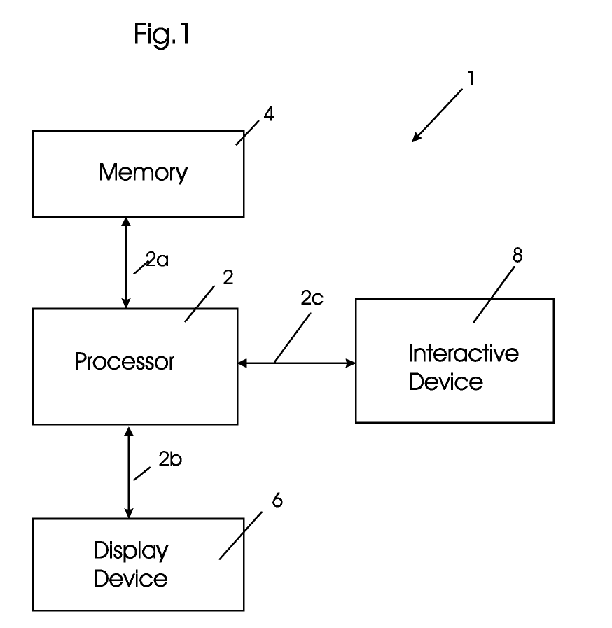

FIG. 1 shows an apparatus 1 including a computer memory 4 for use in accordance with one or more embodiments of the present invention. The apparatus 1 also includes a processor 2, a display device 6, and an interactive device 8. The processor 2 is connected to the memory 4, the display device 6, and the interactive device 8 by communication lines 2a, 2b, and 2c, respectively. The processor 2 may be a computer processor such as a personal computer. The memory 4 may be computer memory. The display device 6 may be a computer monitor. The interactive device 8 may be a computer keyboard or computer mouse.

The processor 2 is programmed, in accordance with one embodiment of the present invention, to implement a data requirements methodology. The data requirements methodology of one or more embodiments of the present invention develops a set of coherent and comprehensive data requirements that transcend a single database design to encompass an organization or business's data requirements and any external party with whom the data may be shared and exchanged. Data requirements are often used by organizations for many purposes. However, the concept of recording data requirements and developing them into a set of detailed and coherent well defined standardized data requirements within a methodology such as the data requirements methodology of the present invention is unique. The data requirements methodology designed in accordance with one or more embodiments of the present invention is useful for detailing:

what data is required to adequately identify or define data within a specified data context,

what data is required by an organization for external and internal reporting,

what data is required to share information with other organizations,

what data is required from outside sources and how to integrate external data with the organization's data,

what processes are required to derive data and other information that is developed from recorded and collected data,

what transformation methods are required to convert data into a usable form, and

what common data is required to exchange data between databases.

The inputs for a data requirements design could be in many different forms. For example, reports required by governmental agencies are a good source of data requirements. Executive “dashboards” are another good source of data requirements, as are XML (Extensible Markup Language) files used to exchange data between organizations. Legal documents such as contracts are also a source of data requirements to support contract management business processes. In any event, examination of these data sources should yield a single coherent set of data requirements in the form of a data requirements design.

A data requirements methodology in accordance with one or more embodiments of the present invention should not be confused with the standard data modeling diagramming methodology that is firmly entrenched in most organizations as a means to design databases. A data requirements design in accordance with one or more embodiments of the present invention is a very high-level examination and development of an organization's data requirements. As such, a data requirements design in accordance with embodiments of the present invention is typically not a replacement for logical or physical data modeling. A data requirements design in accordance with embodiments of the present invention typically does not address low level database design issues such as data normalization, database table design, database constrain definition, database table indexing, and any other physical database object considerations.

A data requirements methodology in accordance with one or more embodiments of the present invention provides that all data needs be more completely defined so that when removed from its original data context, it is easily understood and integrates smoothly into a new data context. It is important to detail the scope or data context required for all data. There is a need to discover and develop mutual “core” data that facilitates the association of all other data wherever possible. There is also a requirement to design how data will be derived and used by the organization. These are several of the major considerations for a data requirements design in accordance with one or more embodiments of the present invention.

The result of the data requirements methodology may, however, be useful to establish data requirements for the start of a logical data model. A data requirements design in accordance with one or more embodiments of the present invention is an attempt to fill the void between the data management paradigm of today and the standard data modeling methodology. This is not an attempt to replace data modeling but to augment it in a significant way. The outcome of a data requirements design in accordance with one or more embodiments of the present invention, when used, should be an input for a standard data model development. In this way, we can be assured that the resulting data model will be more robust and will inherit from the data requirements methodology characteristics more aligned with the data management needs of today.

In accordance with one or more embodiments of the present invention the following terms are defined:

Data requirements methodology: A design or model that results from the process of collecting data requirements and recording them as objects in the model.

Data value: A data value is typically an alphanumeric value such as “1999” or “hello”.

Requirement Object: A requirement object represents a single named object that is either a defined object type of requirement or a data item type of requirement. Requirement objects are objects placed into the data requirements methodology as the result of some known data requirement. As such, the requirement object reflects the intent of the data requirement with which it is associated.

Defined Object: A defined object is a type of “core” requirements object that identify and/or define persons, places, time periods, methods, and other like objects of interest. Every defined object is grouped into a single interrogatory category based upon which interrogative the defined object is defining or identifying. The interrogatives of interest are Who, What, Where, When, How, or Why. A defined object will only be assigned to a single interrogative. If an object may be assigned to multiple interrogatives, that object is a data item.

Reference String: A group of defined objects, all from the same interrogative, which from a hierarchical pattern. In this pattern, a defined object, of least granularity, is the parent object of another defined object that is more granular in scope. That more granular defined object may than be the parent object to another defined object that is again more granular in scope.

Data item: A data item is a requirement object that may not be a defined object. Data items often represent quantitative or qualitative types of data. However, data items may be documents, books, reports, pictures and audio types of data as well. There are far more data items than there are defined objects. A data item is always linked or associated to one or more defined objects that define the significance of the data item in the data requirements methodology.

Data Context: A data context is the scope or domain of identifying data values for which defined objects may be uniquely identified. For example, the name of a town or city is often not unique around the world. The city name of Washington is not by itself unique in the world. The country name must be added to the city name to help identify the city. By adding the county identifier to the city name, we are changing the data context or the scope of the city name. The data context is now at the country level. However, this still is not enough as a country may have more than one Washington city name. In this case, the data context must again be refined by the state name for example. On the other hand, if instead of the city name we use the combination of center city latitude and longitude, there is no ambiguity and the data context may be referred to as “universal”. That is, any city on the earth may be uniquely identified with the latitude and longitude combination and everyone will understand the significance of what is identified.

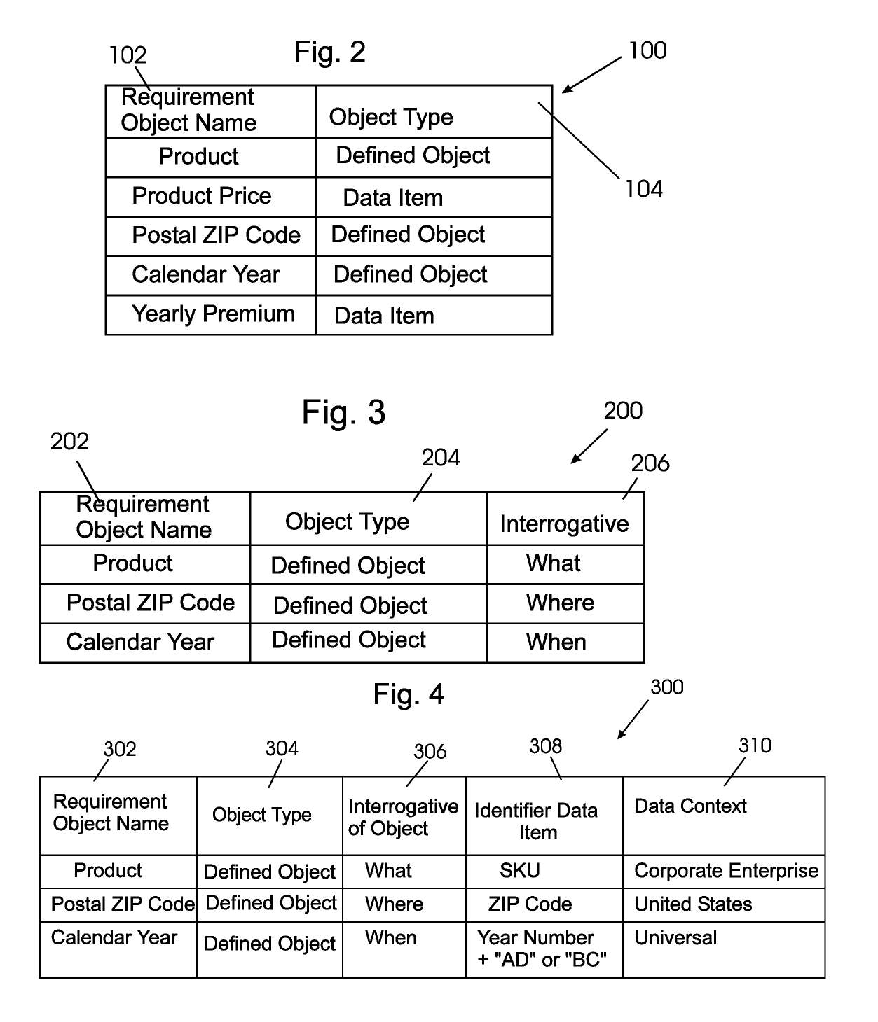

FIG. 2 shows a table of data 100 which may be stored in a computer data base of the computer memory 4 shown in FIG. 1. The table of data 100 may be a spread sheet of data items and an indication of whether each data item is a defined object or not. The table of data 100 includes six rows of data. The first row is a heading row. The second, third, fourth, fifth and sixth rows, provide data regarding the “Product”, “Product Price”, “Postal Zip Code”, “Calendar Year”, and “Yearly Premium” data items, respectively. The table of data 100 includes columns 102 and 104. Column 102 shows a heading for a “Requirement Object Name”, and underneath that heading the data item names “Product”, “Product Price”, “Postal ZIP Code”, “Calendar Year”, and “Yearly Premium”. Column 104 shows a heading for “Object Type” and underneath that an indication of whether the particular data item is a defined object or a data item. For example, the “Product” requirement object name is a defined object.

In accordance with one or more embodiments of the present invention, all defined objects are classified into an interrogative group as shown by FIG. 3. FIG. 3 shows a table of data 200 which may be stored in a computer data base of the computer memory 4 shown in FIG. 1. The table of data 200 includes four rows of data. The first row is a heading row. The second, third, and fourth rows, provide data regarding the “Product”, “Postal ZIP Code”, and “Calendar Year” data items, respectively. The table of data 200 includes columns 202, 204, and 206. Column 202 shows a heading for a “Requirement Object Name”, and underneath that heading the data item names “Product”, “Postal ZIP Code”, and “Calendar Year”. Column 204 shows a heading for “Defined Object” and underneath that an indication of whether the particular data item is a defined object. Column 206 shows a heading of “Interrogative” and underneath that an indication of what interrogative the particular defined object refers to. For example, the “Product” data item is a defined object, and answers the interrogative of “What”. Classifying the data items in this manner develops core defined objects for a data requirements methodology in accordance with the present invention. It is this core defined objects that when properly architected, is the framework for defining the significance of all data items. The core reference data requirements become extremely important for integrating data from various sources or from different data contexts. These core reference data requirements are also important for sharing data with other parties. Properly classifying the defined objects with their interrogative is a first step in fully developing these data requirements in accordance with one or more embodiments of the present invention.

In the table of data or spreadsheet 200 defined objects are assigned to their interrogative. The table of data 200 is stored in the memory 4 so that the processor 2 can lookup a requirement object name and determine whether the requirement object is a defined object and what interrogative is assigned to the particular requirement object name. For example, the processor 2 can examine or lookup in the table 200 in memory 4 to determine whether the “Product” requirement object is a defined object and if so what interrogative is assigned to the “Product” defined object. In this case the “Product” requirement object is a defined object (as is shown in the column 204 of the second row) and the interrogative of “What” is assigned to the “Product” data item (“What” is shown in column 206 of the second row).

If a requirement object may be assigned to more than one interrogative, that object is not a defined object and is therefore handled as a data item, which is linked to two or more defined objects.

In accordance with one or more embodiments of the present invention, each defined object is typically associated with one or more unique identifier or identifying data items. Identifying data items contain a unique set of data values to distinguish any data value from all other data values in a particular data set. Defined objects are associated with descriptive data values to aid in distinguishing any data value among all other data values in a particular data set. These data set values should be unique within a specific defined data context.

For example, the defined object named “Product” could be associated with several identifying data items based upon the data context being used. For example, a Stock Keeping Unit (SKU) may be used as a unique identifying data item within the data context of a single business. Another example of a unique identifying data item may be the Universal Product Code (UPC), which would typically be unique within the data context of the United States and Canada.

The Universal Product Code (UPC) comes in a variety of standards maintained by the Uniform Coding Council, with different standards pertaining to various industries.

The Stock Keeping Unit (SKU) is typically not identification standard but simply an internal coding convention that is individual to a particular company. As a result, it can be made up of any combination of numbers or letters and of any length. The SKU is of note in this context because it is sometimes a requirement to use a customer-specific SKU identifier on products shipped to that customer, to reduce the re-labeling overhead the customer incurs when putting the product into stock.

One difference between the UPC and the SKU is the data context of scope of the uniqueness of the identifier. While the SKU may be unique within a company, there is no guarantee that it is unique among all corporations. The UPC values, on the other hand, are unique across all United States and Canadian corporations.

FIG. 4 shows a table of data or spreadsheet 300 which may be stored in a computer data base of the computer memory 4 shown in FIG. 1. In the table of data 300 defined objects are identified by unique data items. In addition, the data context for the uniqueness of the identifying data items is also listed. The table of data 300 includes four rows of data. The first row is a heading row. The second, third, and four rows, provide data regarding the “Product”, “Postal ZIP Code”, and “Calendar Year” data items, respectively. The table of data 300 includes columns 302, 304, 306, 308, and 310. Column 302 includes a heading for “Requirements Object Name” and underneath it a plurality of data item names. Column 304 includes a heading for “Object Type” and underneath it a plurality of indications as to whether each requirement object is a defined object. Column 306 includes a heading for “Interrogative of Object” and underneath it the interrogative to which that particular data item refers. Column 308 includes a heading for “Identifying Data Item” and underneath it the identifying data item that is associated with the particular defined object. For example, SKU is an identifier that is associated with the “Product” defined object. Column 310 includes a heading for “Data Context” and underneath it a named data context for the particular identifying data item.

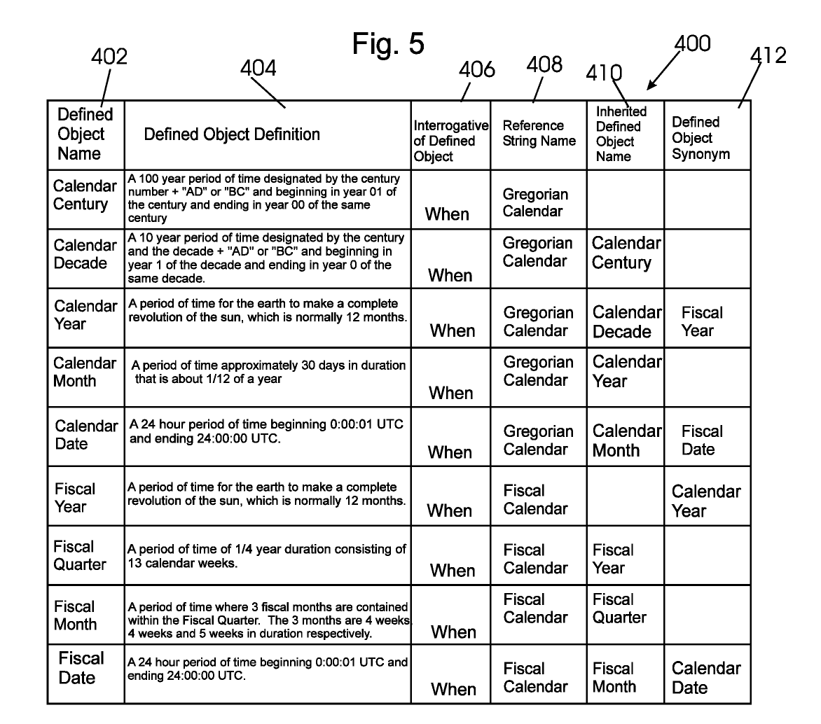

FIG. 5 shows a table of data or spreadsheet 400 which may be stored in a computer data base of the computer memory 4 shown in FIG. 1. The table of data 400 includes ten rows of data. The first row is a heading row. The second, third, fourth, fifth, sixth, seventh, eighth, ninth, and tenth rows, provide data regarding the defined objects “Calendar Century”, “Calendar Decade”, “Calendar Year”, “Calendar Month”, “Calendar Date”, “Fiscal Year”, “Fiscal Quarter”, “Fiscal Month”, and “Fiscal Date”, respectively. The table of data 400 includes columns 402, 404, 406, 408, 410, and 412. Column 402 includes a heading for “Defined Object Name” and underneath it a plurality of defined object names. Column 404 includes a heading for “Defined Object Definition” and underneath it a plurality of defined object definitions each referring to an appropriate defined object of column 402. Column 406 includes a heading for “Interrogative of Defined Object” and underneath it a plurality of interrogatives, each referring to the defined object named in column 402. Column 408 includes a heading for “Reference String Name” and underneath it a plurality of reference string names, each referring to a particular defined object within that reference string. Column 410 includes a heading for “Inherited Defined Object Name” and underneath it a plurality of parent defined object levels, each referring to the like named defined object of Column 402. Column 412 includes a heading for “Defined Object Synonym” and underneath it a plurality of defined object synonyms, each referring to a particular defined object named in column 402.

In accordance with a method of one or more embodiments of the present invention, each defined object must exist within its assigned interrogative as a single defined object or as part of a reference string of other so declared defined objects of the same interrogative. These defined objects define the various levels of granularity for the reference string. For example, we may have a reference string named “Gregorian Calendar” such as referred to in the second through sixth rows of column 408 in FIG. 5. In FIG. 5, the reference string “Gregorian Calendar” is categorized under the “When” interrogative, as shown by the second through sixth rows of column 406 in FIG. 5. In the example of FIG. 5, the reference string “Gregorian Calendar” contains the defined objects of Calendar Century, Calendar Decade, Calendar Year, Calendar Month, and Calendar Date, as shown the second through sixth rows of column 402, where the Calendar Century is the least granular defined object and the Calendar Date is the most granular defined object.

A reference string may represent a hierarchy of data items as in the previous example for “Gregorian Calendar” or be part of a network of defined objects that cross multiple reference strings. Assume we also define the corporate “Fiscal Calendar” reference string referred to in the seventh through tenth rows of column 408 of FIG. 5, which includes the following defined objects: Fiscal Year, Fiscal Quarter, Fiscal Month, and Fiscal Date. The corporate Fiscal Calendar reference string would share the Fiscal Date defined object with the Gregorian Calendar reference string Calendar Date defined object. Two defined objects that are each a part of a different reference string, but share a common data set result become part of a network type reference string. The network reference strings' common defined objects are either the same defined object with synonymous names, or value subsets of the same defined object.

FIG. 5 depicts two networked reference strings: “Gregorian Calendar” and “Fiscal Calendar”. First, to have a reference string, all defined objects must be from the same interrogative. In FIG. 5, both reference strings contain defined objects from the “when” interrogative. Both the Gregorian Calendar reference string (in the second through sixth rows) and the Fiscal Calendar reference string (in the seventh through tenth rows) are hierarchical in nature having several levels of granularity. Since the synonymous defined objects are from different reference strings, the result is a set of networked reference strings.

In accordance with a method of one or more embodiments of the present invention, all data items must be linked or associated to at least one defined object. These links are required so that the significance of the data item may be detailed. Many times a single data item may be linked to many defined objects to be more completely defined. To be completely defined, the data item should be linked to at least one reference string for each of the interrogatives. In some cases, a data item may have multiple links to the same interrogative.

A data item without a link to any defined objects is of little value. For example, a data item named Distance may have a data value of 14. What is the significance of this value? It is the reference strings and defined objects that identifies the starting and ending location, and the units of measure, who measured the distance, how and when the distance was measured as well as why the distance was measured. In a sense, the links of data items to defined objects indicates the significance of the data item and “classify” the data item in association to all other “linked” data items. In other words, two data items linked to common defined objects are therefore closely classified data items. Two data items linked to totally different defined objects are not closely classified data items.

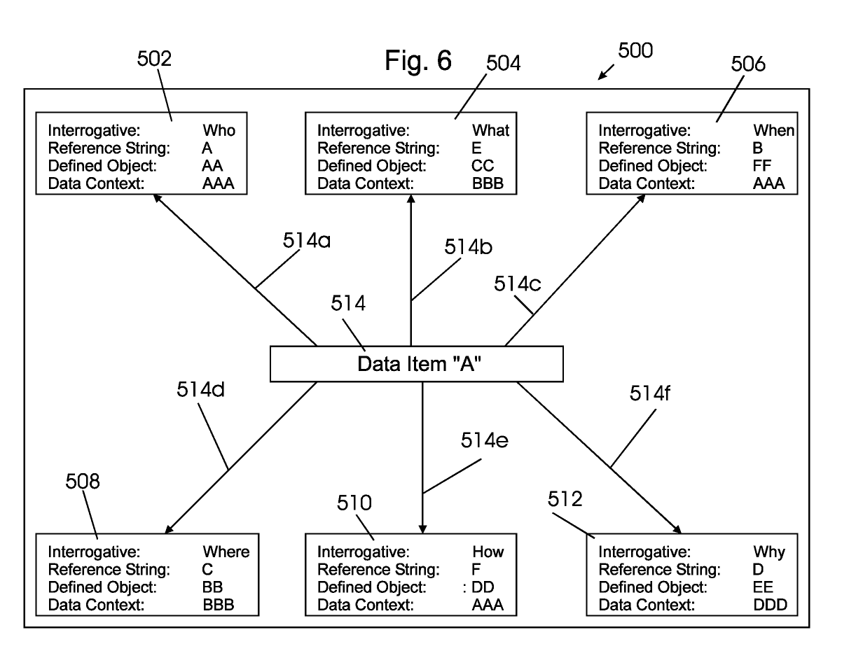

FIG. 6 is a diagram 500 of a depiction of single data item class 514 that contains data item “A” or that is “completely” classified by links to at least one defined object from each interrogative. Diagram 500 shows defined objects 502, 504, 506, 508, 510, and 512. For example, defined object 502 refers to a defined object named “AA”, which is part of reference string A, and detailed by data context AAA. The defined object AA provides data concerning the “Who” interrogative. Data item class 514 is associated with defined objects by links 514a, 514b, 514c, 514d, 514e, and 514f to the defined objects 502, 504, 506, 508, 510, and 512 respectively. The links 514a-f may be documented in a database table on a computer.

In one or more embodiments of the present invention, data items are classified as either “base”, or “derived”, or “transformed” data items. A “base” type data item is defined in this application as a data item whose values are required to be collected or recorded for an organization. A “derived” data item is defined as a data item that is derived or calculated from other data items within the same data item class. A “transformed” data item is defined as a base data item or a derived data item that is propagated from its original data item class to another required data item class. The reason for the data item class transformation is to allow for the definition of more derived data items within the designated data item class.

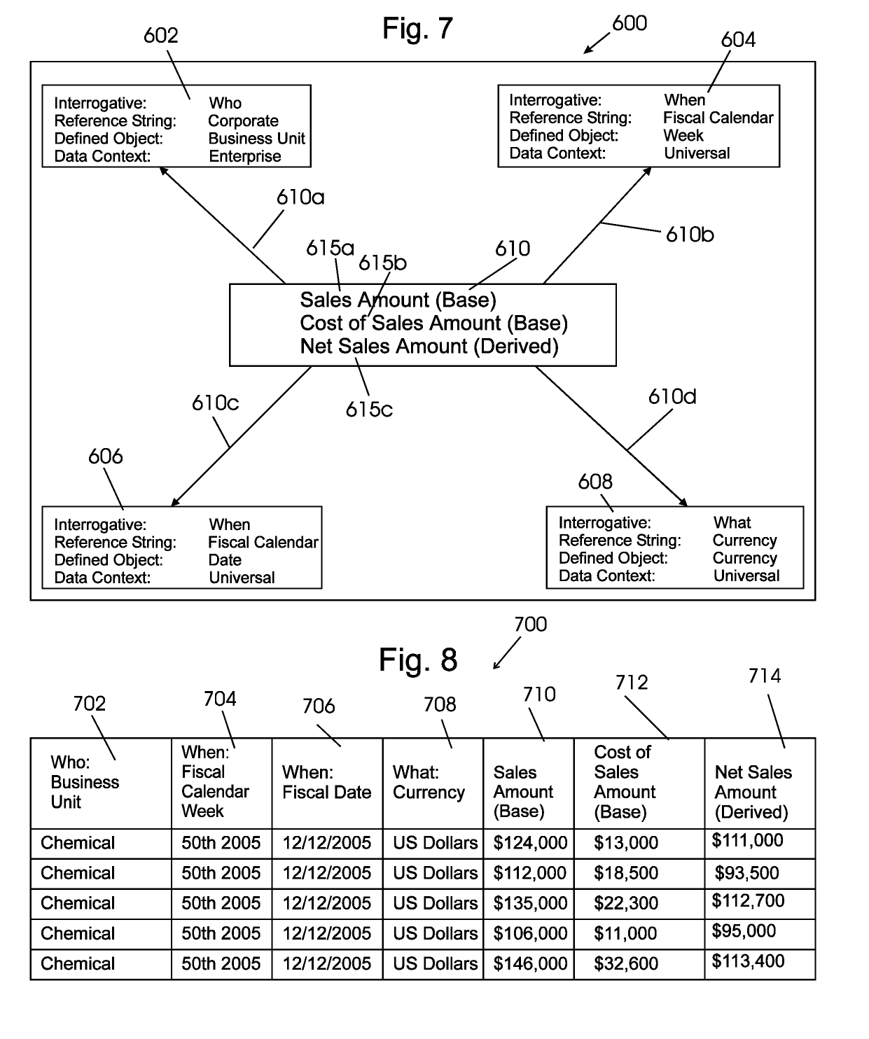

FIG. 7 is a diagram 600 showing the data item classification of “Sales Amount (Base)” in data item class 610, of a data item “Cost of Sales Amount (Base)” in data item class 610, and of a data item “Net Sales Amount (Derived)” in data item class 610. All data items linked to the same defined objects are in the same data item class. Derived data items, which are derived only from data items in the same data item class; also resides within this data item class. Numeric type data item values may be added, subtracted, and converted into a new unit of measure thus forming a derived data item. Data items containing strings of characters may be concatenated or divided into substrings. Even sounds and pictures can be modified to derive new sounds and pictures. FIG. 7 shows a diagram 600, which depicts the derivation of data item “Net Sales Amount (Derived)” as derived from data items “Sales Amount (Base)” and “Cost of Sales Amount (Base)”. The resultant data item “Net Sales Amount (Derived)” in data item class 610 is in the same data item class as the two data items from which the result was derived.

FIG. 7 shows defined objects 602, 604, 606 and 608, linked by links 610a, 610b, 610c, and 610d, respectively, to the three data items depicted in a data item class 610. The data item class 610 includes data items “Sales Amount (Base)” or 615a, “Cost of Sales Amount (Base)” or 615b, and “Net Sales Amount (Derived)” or 615c. The module 610 is used for convenience of classification and the data items 615a, 615b, and 615c may be located at different locations in a computer memory such as memory 4 of FIG. 1.

FIG. 8 shows a table of data or spreadsheet 700 which may be stored in a computer data base of the computer memory 4 shown in FIG. 1. While FIG. 7 is a graphical depiction of a specific data item class, FIG. 8 is a data set from the data item class depicted in FIG. 7. The table of data 700 includes six rows of data. The first row is a heading row. The second, third, fourth, fifth, and sixth rows provided defined object identifiers and data item values. The table of data 700 includes columns 702, 704, 706, 708, 710, 712, and 714. Column 702 includes a heading for the defined object designated “Who: Business Unit”, and underneath it a plurality of business unit identifiers, which in this case are all the same. This column 702 of FIG. 8 is represented by defined object 602 of FIG. 7. Column 704 includes a heading for the defined object designated “When: Fiscal Calendar Week” and underneath it a plurality of fiscal calendar week identifiers, which in this case are all the same. This column 704 of FIG. 8 is represented by defined object 604 of FIG. 7. Column 706 includes a heading for the defined object designated “When: Fiscal Date”, and underneath it a plurality of fiscal date identifiers, which in this case are all the same. This column 706 of FIG. 8 is represented by defined object 606 of FIG. 7. Column 708 includes a heading for the defined object designated “What: Currency” and underneath it a plurality of currency identifies, which in this case are all the same. This column 708 of FIG. 8 is represented by defined object 608 of FIG. 7. Column 710 includes a heading for the data item designated “Sales Amount (Base)” and underneath it a plurality of dollar amount data values. This column 710 of FIG. 8 is represented by data item 615a of FIG. 7. Column 712 includes a heading for the data item designated “Cost of Sales Amount (Base)” and underneath it a plurality of dollar amount data values. This column 712 of FIG. 8 is represented by data item 615b of FIG. 7. Column 714 includes a heading for the derived data item designated “Net Sales Amount (Derived)” and underneath it a plurality of dollar amount data values. This column 714 of FIG. 8 is represented by data item 615c of FIG. 7. The data items in columns 710, 712, and 714 are all associated to the same data item class, which is depicted by the data item class 614 of FIG. 7.

The table of data 700 or spreadsheet in FIG. 8, shows how the data item “Net Sales Amount (Derived)” values of column 714 are derived by subtracting the data item “Cost of Sales Amount” values of column 712 from the data item “Sales Amount” values of column 710. The derived data items reside in the same data item class as the original data items from which it was derived. This is evident in that all identifying values of the defined objects in columns 702, 704, 706, and 708 are the same for all rows of data represented.

In accordance with one or more embodiments of the present invention, data items may be transformed from one data item class to another data item class by applying one or more of several data item class transformation methods. Some of these data item class transformation methods are:

a reference string aggregation method,

a reference string allocation method,

a reference string augmentation method, and

a reference string consolidation method.

This ability to represent data items in various data item classes is part of what makes the data requirements methodology in accordance with embodiments of the present invention useful. Most information that is strategically important to an organization is not individual transaction details that are most often recorded to support daily operations of the organization. The most strategically important information is typically summarized, integrated business data enriched with data from external sources. The data requirements methodology of embodiments of the present invention that facilitate this information building process are related to the development of common defined objects and to the ability to transform data items to common data item classes where new data items may be derived.

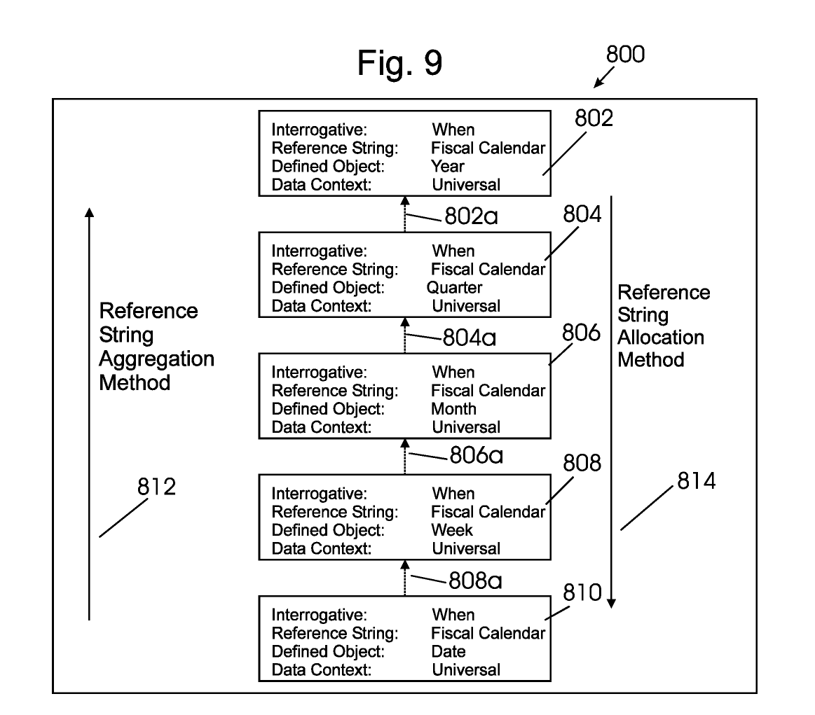

By using data item class transformation methods in accordance with embodiments of the present invention, a single data item can be represented in as many different data item classes as needed to support the organization's information building requirements. The reference string aggregation method is used to move to a less granular data item class while the reference string allocation method is used to move to a more granular data item class. These changes in reference string granularity are depicted in FIG. 9.

In FIG. 9, the fiscal calendar string is depicted with five defined objects each representing a level of granularity within the hierarchical reference string. FIG. 9 shows a diagram 800, which includes defined objects 802, 804, 806, 808, and 810. Each of the defined objects includes a defined object name, the interrogative it refers to, the reference string that the particular defined object is a part of, the data context associated with the defined object. The defined objects 802, 804, 806, and 808 are inherited via links 802a, 804a, 806a, and 808a by defined objects 804, 806, 808, and 810, respectively. FIG. 9 shows arrows 812 and 814, which indicate the direction of change in reference string granularity achieved with the use of the named data item class transformation methods. That is, the reference string aggregation method transforms a data item from its original data item class by disassociating from one define object and associating to a less granular defined object on the same reference string. On the other hand, the reference string allocation method transforms the data item from its original data item class by disassociating from one defined object and associating to a more granular defined object on the same reference string.

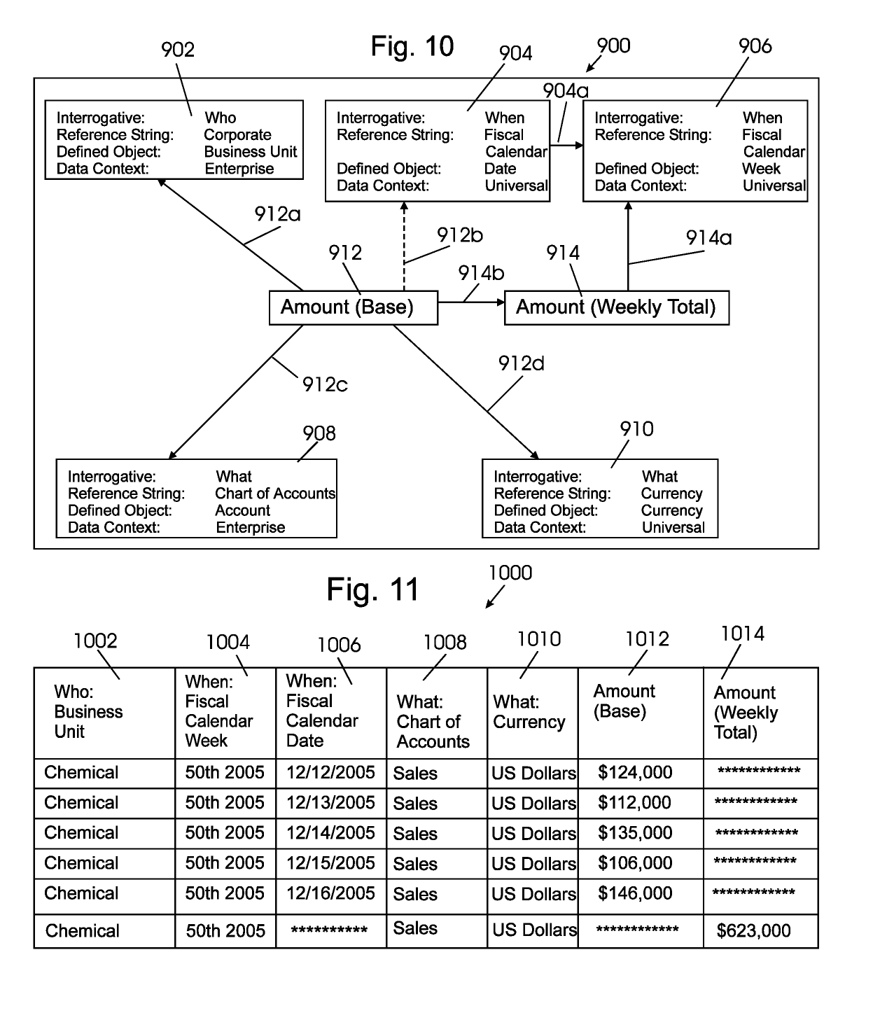

The results of the reference string aggregation method are depicted in FIG. 10. FIG. 10 shows a diagram 900, which includes defined objects 902, 904, 906, 908, and 910 along with data item classes 912, and 914. The defined objects 902, 904, 908, and 910 are linked to data item class 912 by links 912a, 912b, 912c, and 912d, respectively. Each of the links 912a-d may be stored in a database table. The defined object 906 inherits from defined object 904 by link 904a. Defined object 906 is linked to data item class 914 by link 914a. The data item class 912 is transformed by 914b to the data item class 914.

The inheritance 904a, the new association 914a, and the disassociation 912b show the impact of the reference string aggregation method. The change in granularity occurs in the fiscal calendar reference string by transforming from the fiscal calendar date defined object 904 to the fiscal calendar week defined object 906. The data item named Amount (Base) 912 is aggregated into a new data item named Amount (Weekly Total) 914. The resulting data item class inherits all the links of the original data item class represented by the arrows or links 912a, 912c, and 912d. The link being replaced is represented by the arrow or link 912b. Since the level of granularity has decreased in the fiscal calendar reference string, the aggregated data item exists in a different data class than the original data item.

FIG. 11 shows a table of data or spreadsheet 1000, which may be stored in a computer data base of the computer memory 4 shown in FIG. 1. While FIG. 10 is a graphical depiction of a specific data item class transformation, FIG. 11 is a data set undergoing the same data item class transformation as that depicted in FIG. 10. The table of data 1000 includes seven rows of data. The first row is a heading row. The second, third, fourth, fifth, sixth, and seventh rows provided defined object identifiers and data item values. The table of data 1000 includes columns 1002, 1004, 1006, 1008, 1010, 1012, and 1014. Column 1002 includes a heading for the defined object designated “Who: Business Unit”, and underneath it a plurality of business unit identifiers, which in this case are all the same. This column 1002 of FIG. 11 is represented by defined object 902 of FIG. 10. Column 1004 includes a heading for the defined object designated “When: Fiscal Calendar Week” and underneath it a plurality of fiscal calendar week identifiers, which in this case are all the same. This column 1004 of FIG. 11 is represented by defined object 906 of FIG. 10. Column 1006 includes a heading for the defined object designated “When: Fiscal Calendar Date”, and underneath it a plurality of fiscal calendar date identifiers, with the exception of the last row which rather a plurality of asterisks which indicate that the fiscal calendar date is not applicable. This column 1006 of FIG. 11 is represented by defined object 904 of FIG. 10. Column 1008 includes a heading for the defined object designated “What: Chart of Accounts” and underneath it a plurality of account identifiers, which in this case are all the same. This column 1008 of FIG. 11 is represented by defined object 908 of FIG. 10. Column 1010 includes a heading for the defined object designated “What: Currency” and underneath it a plurality of currency identifiers, which in this case are all the same. This column 1010 of FIG. 11 is represented by defined object 910 of FIG. 10. Column 1012 includes a heading for the data item named “Amount (Base)” and underneath it a plurality of dollar amount values. This column 1012 of FIG. 11 is represented by the data item in data item class 912 of FIG. 10. Column 1014 includes a heading for the data item named “Amount (Weekly Total)” and underneath it a plurality of dollar amount values. This column 1014 of FIG. 11 is represented by the data item in data item class 914 of FIG. 10. The transformed data item reside in a different data item class than the original data item from which it was transformed. This is evident in that all identifying values of the defined objects in columns 1002, 1004, 1006, and 1008 are not the same for all rows of data represented.

FIG. 11 depicts an example of applying a reference string aggregation method to a data set in accordance with an embodiment of the present invention to a data set. The data records in the table of data 1000 that appear in the second through the sixth rows (i.e. excluding the last row) represent data values before a reference string aggregation method in accordance with the present invention is applied. In this case, the aggregation method results in a single data record that is represented by the data in the last row of the table of data 1000. The last row includes a plurality of data, one data in each of columns 1002-1012. The five data amount values recorded for each day of the fiscal calendar week (i.e. the amounts in the column 1012 and in the second through sixth rows) are summed to provide a single weekly amount (which is $623,000.00 in this case) in the last row of the column 1012. The resultant data record in the last row and the column 1012 appears in a different data item class since the Fiscal Calendar Date is no longer significant to define the resulting data item class.

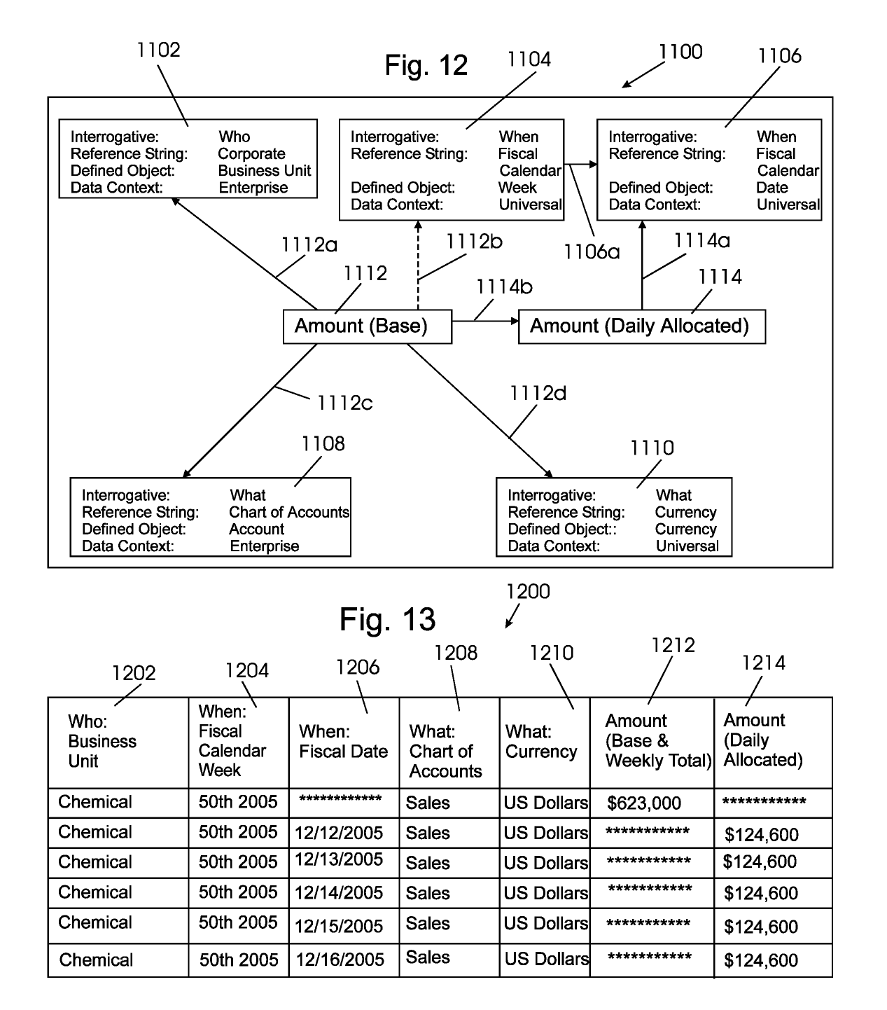

The reference string allocation method in accordance with one or more embodiments of the present invention supports creating a more detailed data item in a more granular data item class within an existing reference string. The results of this method are depicted in FIG. 12. FIG. 12 shows a diagram 1100, which includes defined objects 1102, 1104, 1106, 1108, and 1110 as well as data items 1112, and 1114. The defined objects 1102, 1104, 1108, and 1110 are associated with data item class 1112 by links 1112a, 1112b, 1112c, and 1112d, respectively. Each of the links 1112a-d may be stored in a database table. The defined object 1104 is inherits from defined object 1106 by link 1106a and is also associated with data item class 1114 by link 1114a. The data item “Amount (Base)” in data item class 1112 is transformed to data item “Amount (Daily Allocated)” in data item class 1114 as depicted by arrow 1114b.

The links depicting the disassociated defined object 1112b, the transformed data item class 1114b and the defined object inheritance 1114a show the impact of the data item class transformation method. The change in granularity occurs in the fiscal calendar reference string by transforming the reference string association from the fiscal calendar week defined object shown in defined object 1104 to the fiscal calendar date defined object shown in module 1106. The data item named Amount (Base) shown in data item class 1112 is allocated into a new data item named Amount (Daily Distributed) shown in data item class 1114. Since the level of granularity has increased in a reference string, the allocated data item exists in a different data class than the original data item.

FIG. 13 shows a table of data or spreadsheet 1200, which may be stored in a computer data base of the computer memory 4 shown in FIG. 1. While FIG. 12 is a graphical depiction of a specific data item class transformation, FIG. 13 is a data set from the data item class transformation depicted in FIG. 12. The table of data 1200 includes seven rows of data. The first row is a heading row. The second, third, fourth, fifth, sixth, and seventh rows provide defined object identifiers and data item values. The table of data 1200 includes columns 1202, 1204, 1206, 1208, 1210, 1212, and 1214. Column 1202 includes a heading for the defined object designated “Who: Business Unit”, and underneath it a plurality of business unit identifiers, which in this case are all the same. This column 1202 of FIG. 13 is represented by defined object 1102 of FIG. 12. Column 1204 includes a heading for the defined object designated “When: Fiscal Calendar Week” and underneath it a plurality of fiscal calendar week identifiers, which in this case are all the same. This column 1204 of FIG. 13 is represented by defined object 1104 of FIG. 12. Column 1206 includes a heading for the defined object designated “When: Fiscal Date”, and underneath it a plurality of fiscal date identifiers, with the exception of the second row which does not show a date identifier but rather shows a plurality of asterisks. The plurality of asterisks indicates that this defined object is not applicable for this row. This column 1206 of FIG. 13 is represented by defined object 1106 of FIG. 12. Column 1208 includes a heading for defined object designated “What: Chart of Accounts” and underneath it a plurality of account identifiers, which in this case are all the same. This column 1208 of FIG. 13 is represented by defined object 1108 of FIG. 12. Column 1210 includes a heading for defined object designated “What: Currency” and underneath it a plurality of currency identifiers, which in this case are all the same. This column 1210 of FIG. 13 is represented by defined object 1110 of FIG. 12. Column 1212 includes a heading for the data item “Amount (Base)” and underneath it a dollar amount value. This column 1212 of FIG. 13 is represented by the data item in data item class 1112 of FIG. 12. Column 1214 includes a heading for the data item “Amount (Daily Allocated)” and underneath it a plurality of dollar amount values. This column 1214 of FIG. 13 is represented by the data item in data item class 1114 of FIG. 12.

FIG. 13 shows an example of applying the reference string allocation method to a data set. The data record that appears in the second row represents the data value before the method is applied. In this case, the method results in five data records in the third through seventh rows. The five amount values allocated for each day of the fiscal calendar week (in the third through last rows in column 1214) are derived from the single weekly amount (i.e. $623,000 in the second row of column 1214) by dividing the weekly amount ($623,000) by the number five, which represents the number of business days in the week. The resultant data record in the third through seventh rows appear in a different data item class since the Fiscal Calendar Date is now significant to define the resulting data item class.

The process of allocation in accordance with one or more embodiments of the present invention is based upon some factor used for the allocation. In the above example, the number of business days in the week is the allocation factor. This is a simple approximation, but more elaborate allocation factors are often used.

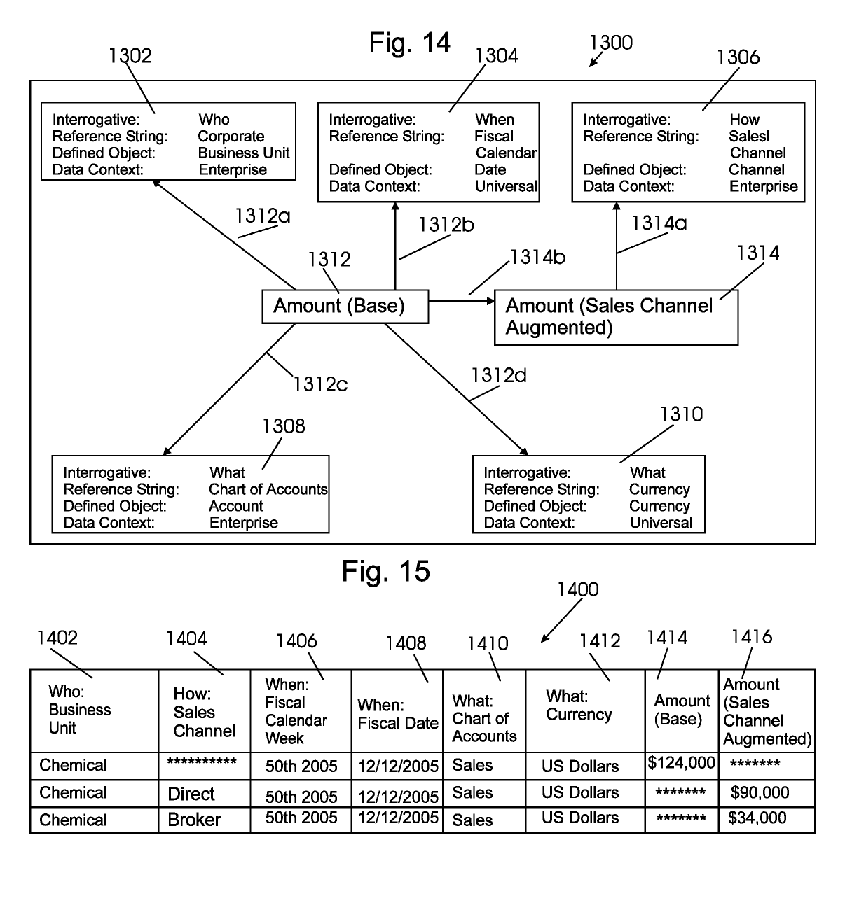

The reference string augmentation method in accordance with one or more embodiments of the present invention supports a change in data requirements where a more detailed data item class is required. The more detailed data item class is attained by adding a link to another defined object in a different reference string. The results of this method are depicted in FIG. 14. FIG. 14 shows a diagram 1300, which includes defined objects 1302, 1304, 1306, 1308, and 1310 as well as data item classes 1312, and 1314. The defined objects 1302, 1304, 1308, and 1310 are associated with data item class 1312 by links 1312a, 1312b, 1312c, and 1312d, respectively. Each of the links 1312a-d may be recorder in a database table. The defined object 1306 is associated to data item class 1314 by link 1314a. The data item class 1312 is transformed to data item class 1314 by transformation link 1314b.

The link or arrow 1314a show defined object 1306 that has been added to further classify the new, resulting data item class 1314. The transformation occurs by the addition of the sales channel reference string association. The data item named Amount (Base) depicted in data item class 1312 is now required in a new, more detailed data item class 1314 that is designated as the data item named Amount (Sales Channel Augmented).

FIG. 15 shows a table of data or spreadsheet 1400, which may be stored in a computer data base of the computer memory 4 shown in FIG. 1. While FIG. 14 is a graphical depiction of a specific data item class transformation, FIG. 15 is a data set representative of the data item class transformation depicted in FIG. 14. The table of data 1400 includes four rows of data. The first row is a heading row. The second, third, and fourth rows provide defined object identifiers and data item values. The table of data 1400 includes columns 1402, 1404, 1406, 1408, 1410, 1412, 1414, and 1416. Column 1402 includes a heading for the defined object designated “Who: Business Unit”, and underneath it a plurality of business unit identifiers, which in this case are all the same. This column 1402 of FIG. 15 is represented by defined object 1302 of FIG. 14. Column 1404 includes a heading for the defined object designated “How: Sales Channel” and underneath it a plurality of identifiers for a sales channel with the exception of the second row which has no sales channel identifier but rather a line of asterisks. This column 1404 of FIG. 15 is represented by defined object 1306 of FIG. 14. Column 1406 includes a heading for the defined object designated “When: Fiscal Calendar Week”, and underneath it a plurality of fiscal calendar week identifiers, which in this case are all the same. Column 1408 includes a heading for the defined object designated “When: Fiscal Date” and underneath it a plurality of fiscal date identifiers, which in this case are all the same. This column 1408 of FIG. 15 is represented by defined object 1304 of FIG. 14. Column 1410 includes a heading for the defined object designated “What: Chart of Accounts”, and underneath it a plurality of chart of account identifiers, which in this case are all the same. This column 1410 of FIG. 15 is represented by defined object 1308 of FIG. 14. Column 1412 includes a heading for the defined object designated “What: Currency” and underneath it a plurality of currency identifiers, which in this case are all the same. This column 1412 of FIG. 15 is represented by defined object 1310 of FIG. 14. Column 1414 includes a heading for the data item designated “Amount (Base)” and underneath it a dollar amount data item value. This column 1414 of FIG. 15 is represented by the data item shown in data item class 1312 of FIG. 14. Column 1416 includes a heading for the data item designated “Amount (Sales Channel Augmented)” and underneath it a plurality of dollar amount data item values. This column 1416 of FIG. 15 is represented by the data item shown in data item class 1314 of FIG. 14.

FIG. 15 depicts an example of applying the reference string augmentation method to a data set. The data record in the second row represents the data before the method is applied. In this case, the applied method results in two data records, shown in the last two rows of FIG. 15. The Amount (Sales Channel Augmented) values for the third and fourth row are calculated from the Amount (Base) value from the second row based upon a sales channel allocation factor. The resultant data records in the third and the fourth row appears in a different data item class since the Sales Channel is now used to define the resulting data item class. The resultant data item in column 1416 of the third and the forth rows appear in a different data item class than does the data item in column 1414, since the Sales Channel is now significant to define the resulting data item class shown in the third and forth rows of spreadsheet 1400.

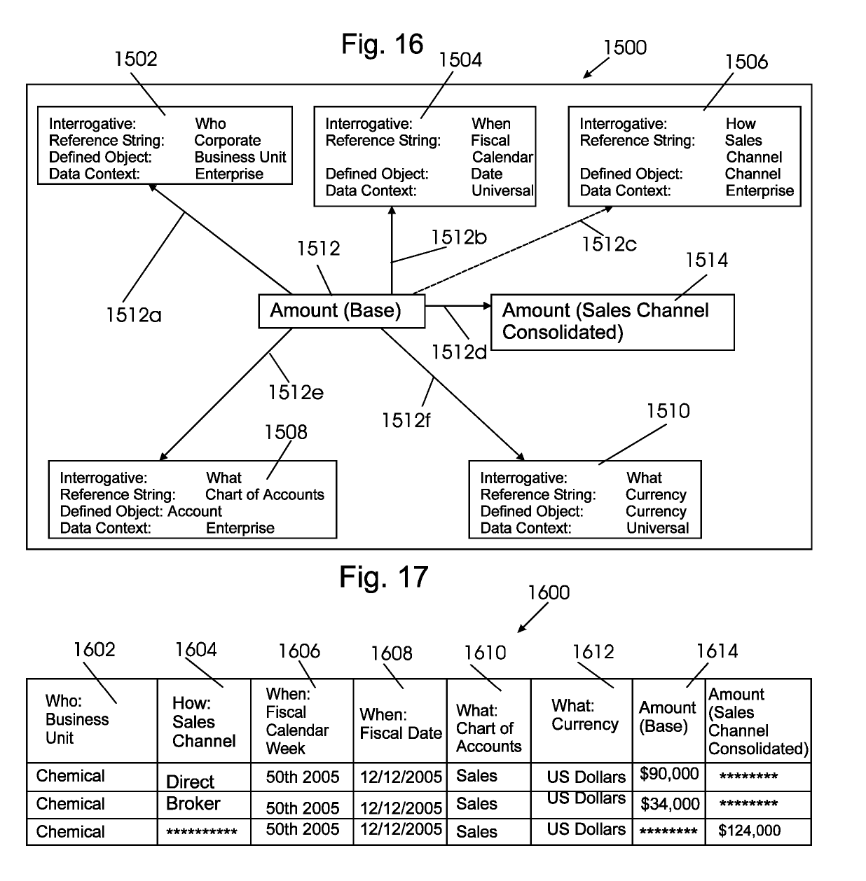

The reference string consolidation method supports a change in data requirements where a less detailed data item class is required. The results of this method are depicted in FIG. 16. FIG. 16 shows a diagram 1500, which includes defined objects 1502, 1504, 1506, 1508, and 1510 as well as data item classes 1512, and 1514. The defined objects 1502, 1504, 1506, 1508, and 1510 are associated to data item class 1512 by links 1512a, 1512b, 1512c, 1512e, 1512f, respectively. Each of the links 1512a-f may be stored in database table. The data item class 1512 is transformed to data item class 1514 as indicated by arrow 1512d.

The link 1512c shows the defined object that has been removed from the resultant data item class 1514, which contains the data item, designated Amount (Sales Channel Consolidated). The change in data item class granularity occurs in the removal of the sales channel reference string association or link 1512c. The data item named Amount (Base) shown in data item class 1512 is now required in a new, less detailed data item class which is designated as Amount (Sales Channel Consolidated) in data item class 1514.

FIG. 17 shows a table of data or spreadsheet 1600, which may be stored in a computer data base of the computer memory 4 shown in FIG. 1. While FIG. 16 is a graphical depiction of a specific data item class transformation, FIG. 17 is a data set representative of the data item class transformation depicted in FIG. 16. The table of data 1600 includes four rows of data. The first row is a heading row. The second, third, and fourth rows provide defined object identifiers and data item values. The table of data 1600 includes columns 1602, 1604, 1606, 1608, 1610, 1612, 1614, and 1616. Column 1602 includes a heading for the defined object designated “Who: Business Unit”, and underneath it a plurality of business unit identifiers, which in this case are all the same. This column 1602 of FIG. 17 is represented by defined object 1502 of FIG. 16. Column 1604 includes a heading for the defined object designated “How: Sales Channel” and underneath it a plurality of identifiers for a sales channel with the exception of the last row which has no sales channel identifier but rather a line of asterisks. This column 1604 of FIG. 17 is represented by defined object 1506 of FIG. 16. Column 1606 includes a heading for the defined object designated “When: Fiscal Calendar Week”, and underneath it a plurality of fiscal calendar week identifiers, which in this case are all the same. Column 1608 includes a heading for the defined object designated “When: Fiscal Date” and underneath it a plurality of fiscal date identifiers, which in this case are all the same. This column 1608 of FIG. 17 is represented by defined object 1504 of FIG. 16. Column 1610 includes a heading for the defined object designated “What: Chart of Accounts” and underneath it a plurality of account identifiers, which in this case are all the same. This column 1610 of FIG. 17 is represented by defined object 1508 of FIG. 16. Column 1612 includes a heading for the defined object designated “What: Currency” and underneath it a plurality of currency identifiers, which in this case are all the same. This column 1612 of FIG. 17 is represented by defined object 1510 of FIG. 16. Column 1614 includes a heading for data items “Amount (Base)” and underneath it a plurality of dollar amount data item values. This column 1614 of FIG. 17 is represented by the data item in data item class 1512 of FIG. 16. Column 1616 includes a heading for data items “Amount (Sales Channel Consolidated)” and underneath it a dollar amount data item value. This column 1616 of FIG. 17 is represented by the data item in data item class 1514 of FIG. 16.

FIG. 17 depicts an example of applying the reference string consolidation method to a data set. The data records in the second and third rows represent the data before the method is applied. In this case, the applied method results in the single data record that is represented in the last or fourth row of the table of data 1600. The Amount (Sales Channel Consolidated) value in column 1614 of the last row is derived from the Amount (Base) values (in the second and third rows of the last column 1614) for the specified sales channels. The resultant data appears in a different data item class since the Sales Channel is not used to define the resulting data item class.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A method comprising
storing a first set of characteristics for each of a first set of one or more defined objects in a computer memory;
storing a second set of characteristics for each of one or more data item classes in a computer memory;
storing a third set of characteristics for each of one or more data items in a computer memory;
linking the first set of one or more defined objects to one of the one or more data item classes;
assigning a first data item of the one or more data items to a first data item class of the one or more data item classes; and
wherein each first set of characteristics is comprised of a defined object name, and a definition, each second set of characteristics is comprised of a list of links that uniquely identify one of the one or more data item classes, and each third set of characteristics is comprised of a data item name and a data item description.

2. The method of claim 1 wherein
the first set of one or more defined objects is linked to the first data item class by one or more links, which are stored in a computer memory.

3. The method of claim 2 wherein
each of the one or more links includes a data item class identifier and a defined object identifier.

4. The method of claim 1 wherein
each first set of characteristics is comprised of a unique identifier, which is stored in a database table in the computer memory.

5. The method of claim 1 wherein
each first set of characteristics is further comprised of an interrogative.

6. The method of claim 5 wherein
each first set of characteristics is comprised of only one interrogative.

7. The method of claim 1 wherein
each first set of characteristics is further comprised of a reference string name.

8. The method of claim 7 wherein
each reference string name identifies a reference string comprised of a second set of one or more defined objects wherein the second set of one or more define objects is similar in classification to the first set of one or more defined objects.

9. The method of claim 1 wherein
each first set of characteristics is comprised of an inherited defined object name.

10. The method of claim 9 wherein
each of the inherited defined object names refers to an inherited defined object which has a fourth set of characteristics which include just one first interrogative and wherein each of the first set of one or more defined objects also includes just one interrogative, which is the same first, interrogative.

11. The method of claim 10 wherein
each of the inherited defined objects of each of the inherited defined object names is of less granular definition than of any of the defined objects of the first set of one or more defined objects.

12. The method of claim 1 wherein
each first set of characteristics is further comprised of a defined object synonym.

13. An apparatus comprising
a computer memory; and
a processor programmed to implement a plurality of data requirements;
wherein the plurality of data requirements is comprised of:
storing a first set of characteristics for each of a first set of one or more defined objects in the computer memory;
storing a second set of characteristics for each of one or more data item classes in the computer memory;
storing a third set of characteristics for each of one or more data items in the computer memory;
linking the first set of one or more defined objects to one of the one or more data item classes;
assigning a first data item of the one or more data items to a first data item class of the one or more data item classes; and
wherein each first set of characteristics is comprised of a defined object name and a definition, and each second set of characteristics is comprised of a list of links that uniquely identify that data item class and each third set of characteristics is comprised of a data item name and a description.

14. The apparatus of claim 13 wherein
each first set of characteristics is further comprised of an interrogative.

15. The apparatus of claim 13 wherein
each first set of characteristics is further comprised of a reference string name.

16. The apparatus of claim 13 wherein
each first set of characteristics is further comprised of an inherited defined object name.

17. The apparatus of claim 13 wherein
each first set of characteristics is further comprised of a defined object synonym.

18. The method of claim 1 wherein
each third set of characteristics is further comprised of a link associating one or more data items to one or more data item classes.

19. The method of claim 18 wherein
each third set of characteristics is further comprised of a data item type.

20. The method of claim 19 wherein
each third set of characteristics is further comprised of a data item method.

21. The method of claim 1 wherein
each second set of characteristics is comprised of a data item class name and a data item class description.

22. The method of claim 1 further comprising
transforming the first data item to form a second data item,
assigning the second data item to a second data item class of the one or more data item classes,
wherein the second data item class is different from the first data item class;
wherein the second data item is comprised of a data item class transformation method name.

23. The method of claim 22 wherein
the first data item class has a first list of links that uniquely identify the first data item class;
the second data item class has a second list of links that uniquely identify the second data item class; and
the first list of links and the second list of links are substantially the same,
wherein the first list of links includes a first defined object link;
wherein the second list of links includes a second defined object link;
and wherein the first and second defined object links are different.

24. The method of claim 23 wherein
the first defined object link is stored in computer memory in a first reference string.

25. The method of claim 24 wherein
the second defined object link is a link to a less granular defined object than the first defined object link and the second data item is an aggregate of the first data item.

26. The method of claim 24 wherein
the second defined object link is a link to a more granular defined object and the second data item is an allocation of the first data item; and
wherein the second data item is comprised of an allocation factor.

27. A method of claim 23 wherein
the second data item is a consolidation based upon the first data item.

28. A method of claim 23 wherein
the second data item is an augmentation based upon the first data item; and
wherein the second data item is comprised of an augmentation factor.

29. The method of claim 1 further comprising
assigning a first set of data items to the first data item class;
deriving a second data item from the first set of data items;
assigning the second data item to the first data item class; and
wherein the second data item includes a description of a method of derivation used to derive the second data item from the first set of data items.
